(19) United States
(12) Patent Application Publication
(10) Pub. No.: US 2015/0277211 A1
(43) Pub. Date: Oct. 1, 2015

(54) Focal-Plane Shutter and Camera

(71) Applicant: Nidec Copal Corporation, Tokyo (JP)

(72) Inventors: Kenta KAWAKAMI, Tokyo (JP); Shunichi NAGANO, Tokyo (JP)

(73) Assignee: Nidec Copal Corporation, Tokyo (JP)

(21) Appl. No.: 14/671,305

(22) Filed: Mar. 27, 2015

(30) Foreign Application Priority Data
Mar. 28, 2014 (JP) 2014-068004
Jun. 27, 2014 (JP) 2014-132207
Jan. 29, 2015 (JP) 2015-014939

(51) Int. Cl. G03B 9/40; H04N 5/235; H04N 5/225

(52) U.S. Cl. CPC G03B 9/40; H04N 5/2254; H04N 5/2353

(57) ABSTRACT

A focal plane shutter includes a bottom board having an opening portion, and a blade member that opens/closes the opening portion. The blade member is formed from a plurality of arms supported rotatably on the bottom board, at least one blade, and a plurality of connecting members that connects the plurality of arms rotatably to the blade. The blade member includes an adhesive member that is provided on at least one of the plurality of arms.

### CROSS-REFERENCE TO RELATED APPLICATIONS

This application claims priority under 35 U.S.C. §119 to Japanese Patent Application Nos. 2014-068004, filed on Mar. 28, 2014, 2014-132207, filed on Jun. 27, 2014, and 2015-014939, filed on Jan. 29, 2015, the entire contents of which being hereby incorporated herein by reference.

### FIELD OF TECHNOLOGY

The present invention relates to a focal plane shutter having blade members for opening/closing an opening portion for exposure, and, in particular, to a focal plane shutter and a camera that include blade members wherein a plurality of arms and at least one blade for opening/closing an opening portion for exposure are connected in a digital camera such as a single-lens camera, a single-lens reflex camera, a mirrorless camera, a rangefinder camera, or the like.

### BACKGROUND

There is a known conventional focal plane shutter having a structure including: an essentially rectangular bottom board having an opening portion for exposure and an elongated hole; an intermediate board having an opening portion for exposure, and for defining a blade chamber, in cooperation with the bottom board, disposed at a prescribed distance from the bottom board; an auxiliary bottom board (a back board) having an elongated hole, for defining the blade chamber in cooperation with the intermediate board, disposed at a prescribed distance from the bottom board and the intermediate board; a first blade (a blade member) that is disposed so as to be able to move in a blade chamber between the bottom board and the intermediate board and a second blade (a blade member) that is disposed so as to be able to move in a blade chamber between the intermediate board and the auxiliary bottom board, so as to open/close the opening portion of the bottom board; a driving member for the first blade cut, disposed to the outside of the bottom board, having a driving pin that is connected to the first blade through the elongated holes of the bottom board and the auxiliary board, for driving the first blade; a driving member for the second blade, disposed to the outside of the bottom board, having a driving pin that is connected to the second blade through the elongated holes of the bottom board and the auxiliary bottom board, for driving the second blade; and shock absorbing members, made from rubber, secured to end portions of the elongated hole of the bottom board so as to mitigate impacts through the driving pin of the driving member for the first blade and the driving pin of the second blade driving member contacting therewith at the end of a shutter operation, wherein: a plurality of through holes is provided in a mesh-like structure in the bottom board and in an auxiliary board that is secured to the bottom board; an adhesive sheet is disposed between the bottom board and the auxiliary board; and a plurality of through holes is provided in a mesh-like structure in the auxiliary bottom board and in an auxiliary board that is secured to the auxiliary bottom board; wherein: an adhesive sheet is disposed between the auxiliary bottom board and the auxiliary board so as to trap, through causing adhesion to the adhesive sheet, rubbing debris that is produced through sliding, or the like, of the movable members, and the like. See, for example, Japanese Unexamined Patent Application Publication No. 2003-280066.

However, because, in this focal plane shutter, the adhesive sheet is disposed across a broad range, so as to surround the opening portions, a large amount of adhesive sheet is used, and a dedicated auxiliary board is required for holding the adhesive sheet, thus leading to an increase in the number of components, and because an additional adhesive sheet and auxiliary board are disposed on the bottom board side and an adhesive sheet and auxiliary board are disposed on the auxiliary bottom board side, in the direction in which the bottom board, the intermediate board, and the auxiliary bottom board are arranged, this causes the device to be larger in the direction of thickness.

Moreover, the blade members are formed through a plurality of arms, a plurality of blades, and connecting members (rivets) for connecting movably therebetween, and although the rubbing debris may be produced through sliding even in the region of the connecting members, in addition to through the reciprocating motion of the connecting members in the path that faces the opening portion, when performing opening/closing operations for the blade members, no adhesive sheet at all is disposed in the regions of the opening portions, and thus the rubbing debris, and the like, that is produced around the connecting members may be scattered and may, directly through the opening portion, get into the region wherein the imaging element is disposed, so this has not been a reliable countermeasure to prevent the incursion of contamination (that is, has not been a reliable contamination countermeasure).

In particular, given the increasing pixel counts of imaging elements in recent years, contamination, such as rubbing debris, that adheres to the imaging surface of an imaging element has an effect that extends to a number of pixels and to a size that, conventionally, would have had no negative effect, and thus there is the need for countermeasures that can more reliably prevent the incursion of contamination.

The present invention was created in contemplation of the situation described above, and an aspect thereof is to provide a focal plane shutter, and camera using the same, wherein it is possible to achieve a simplification in structure, a reduction in the number of components, and miniaturization of the device, while reducing or preventing the incursion, into the imaging element side, of scattered contamination, such as rubbing debris, or the like, produced in the blade members that open and close the opening portion of the bottom board, to thereby enable production of images with higher definition.

### SUMMARY

A focal plane shutter according to the present invention includes: a bottom board having an opening portion; and a blade member that opens/closes the opening portion. The blade member is formed from a plurality of arms supported rotatably on the bottom board, at least one blade, and a plurality of connecting members that connects the plurality of arms rotatably to the blade. The blade member includes an adhesive member that is provided on an aforementioned arm.

In this structure, the blade members rotating (relative to the bottom board) causes the arms and blades to rotate relatively around the connecting members, to cause the blades of the blade member to open and close the opening portion.

Because here, relative movement (sliding) is produced between the connecting members and the arms and/or blades, the state is one wherein rubbing debris, or the like, may be produced, and in the vicinity of the connecting members, the rubbing debris, or the like, that is produced will adhere to, for example, the surfaces of the arms (through, for example, static electricity). Because here an adhesive member (for example, a double-sided adhesive sheet that is attached to the surface of the arm, or an adhesive agent, or the like, coated in a thin film on the surface of the arm) is provided on a surface of the arm (on one surface or both surfaces), the contamination, such as the rubbing debris, or the like, that is produced, will adhere to the adhesive member to be trapped prior to being scattered by being vibrated off through the operation of the blade member. Because of this, it is possible to reduce or prevent contamination such as rubbing debris, and the like, that is produced in the blade members and then scattered, where this rubbing debris, and the like would have arrived at, and adhered to, the imaging element, or the like, that is disposed behind.

In the structure set forth above, a structure may be employed wherein an adhesive member is disposed in the vicinity of at least a connecting member.

Because, in this structure, an adhesive member (for example, a double-sided adhesive sheet that is adhered to the surface of the arm, or an adhesive agent, or the like, that is coated in the form of a thin film onto the surface of the arm, or the like) is provided at a surface (on one surface or both surfaces) of an arm in the vicinity of the connecting member, the contamination, such as rubbing debris that is produced in the vicinity of the connecting member is trapped through adhesion to the adhesive member immediately. Because of this, it is possible to reduce or prevent contamination such as rubbing debris, and the like, that is produced and then scattered, where this rubbing debris, and the like would have arrived at, and adhered to, the imaging element, or the like, that is disposed behind.

In the structure set forth above, a structure may be employed wherein the arm has a connecting hole for connecting a driving pin, and the adhesive member is arranged (in, for example, a ring shape or an arc shape) in the vicinity of the connecting hole.

Given this structure, when there is relative sliding with the driving pin in a state wherein it is inserted into the connecting hole, contamination, such as the rubbing debris that is produced in the vicinity of the connecting hole, is trapped through adhering immediately to the adhesive member. Because of this, it is possible to reduce or prevent contamination such as rubbing debris, and the like, that is produced and then scattered, where this rubbing debris, and the like would have arrived at, and adhered to, the imaging element, or the like, that is disposed behind.

In the structure set forth above, a structure may be employed wherein the connecting member includes a head portion that is in contact with one face of the arm and a trunk portion that is fitted rotatably into a fitting hole of the arm and fitted into a fitting hole of the blade and wherein a crimping process is performed, where the adhesive member is disposed in a ring shape surrounding the head portion on one face of the arm.

In this structure, the connecting member is subjected to a crimping process (wherein the tip end region of the trunk portion is crushed) after the trunk portion is inserted into the fitting hole of the arm and into the fitting hole of the blade, to thereby be secured integrally with the blade and also assembled into a state wherein the head portion and the trunk portion slide relative to the one face (which is in contact with the head portion) of the arm and relative to the inner peripheral surface of the fitting hole.

Because here a ring-shaped (for example, a circular ring-shaped or elliptical ring-shaped) adhesive member is provided around the head portion on one face of the arm, the rubbing debris, or the like, that is produced in the region of contact between the head portion and (the one face of) the arm is trapped through adhesion, by the ring-shaped adhesive member that is provided in the vicinity, prior to the scattering that is caused by the adhesion around the head portion (through, for example, static electricity, or the like) and the effects of falling off due to the centrifugal force, or the like, accompanying the operation of the arm.

Providing, in this way, the adhesive member in a ring shape on only one face of the arm, wherein the head portion is positioned, and around the head portion enables a reduction in weight while reducing the number of parts, while still preventing scattering by capturing efficiently the rubbing debris, and the like, that is produced.

The structure set forth above may employ a structure wherein a ring-shaped marking line is provided around the head portion of the connecting member.

In this structure, a ring-shaped marking line is provided around the head portion on one face of the arm, enabling the adhesive member to be adhered with high precision at the prescribed position around the head portion on the outside thereof (so as to not be adhered over the marking line) using the marking line as a guide, for example, enabling the adhesion operation to be performed easily.

The structure set forth above may employ a structure wherein the connecting member includes a head portion that is in contact with one face of the arm and a trunk portion that is fitted rotatably into a fitting hole of the arm and fitted into a fitting hole of the blade and wherein a crimping process is performed, and the adhesive member is disposed to form a plane to cover a region that excludes the head portion on one face of the arm.

In this structure, the connecting member is subjected to a crimping process (wherein the tip end region of the trunk portion is crushed) after the trunk portion is inserted into the fitting hole of the arm and into the fitting hole of the blade, to thereby be secured integrally with the blade and also assembled into a state wherein the head portion and the trunk portion slide relative to the one face (which is in contact with the head portion) of the arm and relative to the inner peripheral surface of the fitting hole.

Because here an adhesive member that forms a plane for covering a region that excludes the head portion (for example, a sheet shape that covers essentially the entirety of one face and that includes a circular hole for exposing the head portion), the rubbing debris, or the like, that is produced in the region of contact between the head portion and (the one face of) the arm is trapped through adhesion, by the plane-shaped member that covers the one face of the arm adhesive member, prior to the scattering that is caused by the adhesion around the head portion (through, for example, static electricity, or the like) and the effects of falling off due to the centrifugal force, or the like, accompanying the operation of the arm.

Providing, in this way, the adhesive member in the shape of a plane (so as to cover essentially the entire surface), excluding the head portion, on one face of the arm, enables prevention of scattering by capturing, with increased efficiency commensurate with the added area of the adhesive, rubbing debris, and the like, that is produced, while reducing the number of parts.

The structure set forth above may employ a structure wherein the adhesive member is disposed excluding a region from the vicinity of the connecting member, of the plurality of connecting members, that is positioned the nearest toward the free end side of an aforementioned arm, up to the free end side.

Given this structure, an adhesive member is provided to form a plane on one face of the arm, disposed excluding a region from the vicinity (of the head portion) of the connecting member that is positioned nearest toward the tip end side of the connecting member, up to the free end side (for example, so that the area around the head portion is excluded in a semicircular shape from essentially the center of the head portion toward the tip end side), and thus even if there is a rattling in the tip end side of the arm at the time of operation, the adhesive member will not peel and fall off due to deformation due to the rattling, making it possible to ensure the expected operating characteristics.

The structure set forth above may employ a structure wherein the adhesive member is formed to a thickness dimension that is less than a height dimension of the head portion.

Given this structure, the adhesive member is provided on one face of the arm with a thickness that does not protrude further than the head portion of the connecting member, thus making it possible to prevent the adhesive member from interfering with, and sticking to, a stationary member, such as the bottom board, or the like, thus enabling the blade members to move smoothly.

The structure set forth above may employ a structure that includes a back board, disposed at a distance from the bottom board, for defining a blade chamber in cooperation with the bottom board, and having an opening portion; and an intermediate board, disposed between the bottom board and the back board, for dividing the blade chamber into two parts, a first blade chamber and a second blade chamber, and having an opening portion, wherein: the blade member includes a first blade member that is disposed in either the first blade chamber or the second blade chamber, for opening the opening portion, and a second blade member, disposed in the other of the first blade chamber or second blade chamber, for closing the opening portion, at the time of a shutter operation; wherein: an adhesive member that is disposed on an arm of the first blade member and an adhesive member that is disposed on an arm of the second blade member are arranged so as to face in the directions of respective opposite sides of the intermediate board.

Given this structure, the first blade member is driven open/closed along the face of the intermediate board on one side, and the second blade member is driven open/closed along the face on the other side of the intermediate board to carry out to the shutter operation (the exposing operation).

Here the contamination, such as rubbing debris that is produced from the regions of the connecting members for the first blade member and the second blade member is trapped by adhering to the adhesive members, provided on the respective arms, prior to vibrating off and being scattered due to the operation of the first blade member and the second blade member, and the adhesive members that are provided on the arms of the first blade member and the adhesive members that are provided on the arms of the second blade member are arranged facing in the directions of the respective opposite sides of the intermediate board, thereby enabling prevention of the respective adhesive members from interfering with, and sticking to, the intermediate board, thereby enabling smooth movement of the first blade member and the second blade member along the intermediate board.

A camera according to the present invention includes a focal plane shutter of any of the structures described above and an imaging element that is disposed behind the focal plane shutter.

This structure enables reduction or prevention of contamination, such as rubbing debris that is produced in the regions of the connecting members of the blade members from scattering and entering into the imaging element side, thereby enabling imaging of high-definition images, while enabling simplification of the structure and achieving miniaturization of the device.

This focal plane shutter structured as set forth above makes it possible to obtain a focal plane shutter and a camera that enable reduction or prevention of contamination, such as rubbing debris that is produced in the regions of the connecting members of the blade members from scattering and entering into the imaging element side, thereby enabling imaging of high-definition images, while enabling simplification of the structure and achieving miniaturization of the device.

### BRIEF DESCRIPTIONS OF THE DRAWINGS

FIG. 1 illustrates an example of a focal plane shutter according to the present invention, being a plan view diagram illustrating a state wherein blade members (the first blade member and second blade member) are in the setting position prior to a shutter operation (prior to an exposing operation).

FIG. 2 is a plan view diagram illustrating the state, in the focal plane shutter illustrated in FIG. 1, wherein the blade members (the first blade member and second blade member) have completed the shutter operation.

FIG. 3 is a partial cross-sectional diagram illustrating an imaging element structured from the bottom board, the intermediate board, the back board, the first blade member, and the second blade member, and a camera, illustrated in FIG. 1.

FIG. 4 is a partial plan view diagram illustrating a portion of the blade members (the first blade member) and the adhesive members included in the focal plane shutter illustrated in FIG. 1.

FIG. 5 is a partial plan view diagram illustrating a portion of the blade members (the second blade member) and the adhesive members included in the focal plane shutter illustrated in FIG. 1.

FIG. 6 is a partial plan view illustrating the blade members (the arms, blades, and connecting members) and adhesive members illustrated in FIG. 4 and FIG. 5.

FIG. 7 is a partial cross-sectional diagram illustrating the blade members (arms, blades, and connecting members) and adhesive members illustrated in FIG. 6.

FIG. 8 is a partial plan view diagram illustrating another example of a portion of the blade members (wherein the first blade member and second blade member have been replaced by a first blade member and a second blade member of a somewhat different shape) and adhesive members included in the focal plane shutter illustrated in FIG. 1.

FIG. 9 is a partial plan view diagram illustrating yet another example of a portion of the blade members (wherein the first blade member and second blade member have been replaced by a first blade member and a second blade member of a somewhat different shape) and adhesive members included in the focal plane shutter illustrated in FIG. 1.

FIG. 10 is a partial plan view diagram illustrating yet another example of a portion of the blade members (wherein the first blade member and second blade member have been replaced by a first blade member and a second blade member of a somewhat different shape) and adhesive members included in the focal plane shutter illustrated in FIG. 1.

FIG. 11 is a partial cross-sectional diagram illustrating blade members (arms, blades, and connecting members) and adhesive members in a state wherein the driving pins are inserted in the connecting holes in the example illustrated in FIG. 10.

FIG. 12 illustrates yet another example of a focal plane shutter according to the present example, a partial cross-sectional diagram illustrating an imaging element structured from the bottom board, the intermediate board, the back board, the first blade member, and the second blade member, and a camera.

FIG. 13 is a plan view diagram illustrating the blade members (the first blade member) and the adhesive members included in the focal plane shutter illustrated in FIG. 12.

FIG. 14 is a plan view diagram illustrating the blade members (the second blade member) and the adhesive members included in the focal plane shutter illustrated in FIG. 12.

FIG. 15 is a partial cross-sectional diagram illustrating the blade members (the arms, blades, and connecting members) and adhesive members illustrated in FIG. 13 and FIG. 14.

### DETAILED DESCRIPTION

Examples according to the present invention will be explained below in reference to the appended drawings.

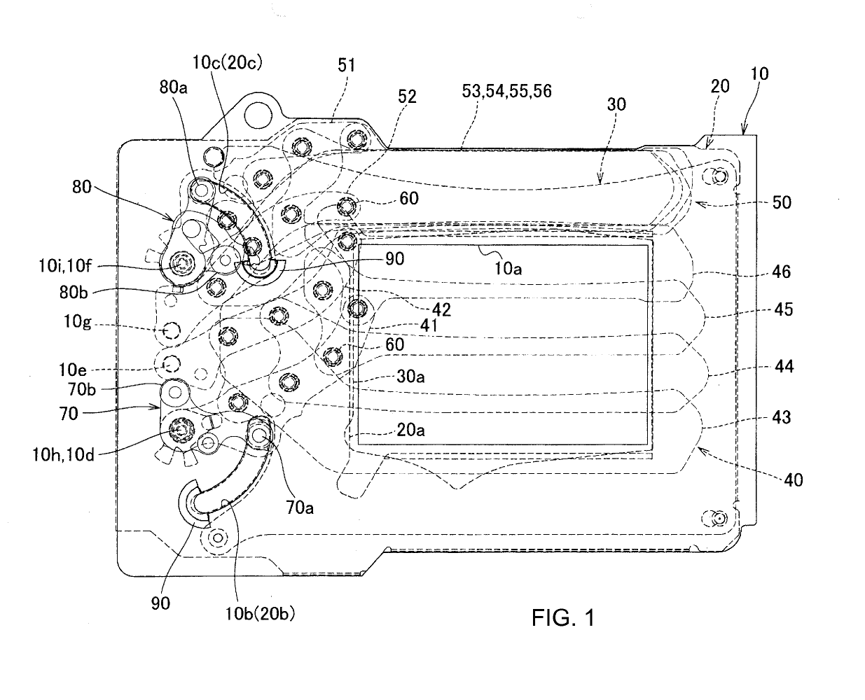

The focal plane shutter according to this example, as illustrated in FIG. 1 through FIG. 3, includes: a bottom board 10 having an opening portion 10a for exposure and two elongated holes 10b and 10c; a back board 20 that is disposed at a prescribed distance from the bottom board 10 and that has an opening portion 20a for exposure and two elongated holes 20b and 20c; an intermediate board 30 that is disposed between the bottom board 10 and the back board 20 and that has an opening portion 30a for exposure; a first blade member 40, as blade member that is disposed so as to be able to move in a first blade chamber W1 between the bottom board 10 and the intermediate board 30; a second blade member 50 as blade member that is disposed so as to be able to move in a second blade chamber W2 between the intermediate board 30 and the back board 20; adhesive members 60 that are provided on the first blade member 40 and the second blade member 50; a first blade driving member 70 as a driving member that is disposed so as to be able to move on the outside of the bottom board 10 so as to drive the first blade member 40; a second blade driving member 80 as a driving member that is disposed so as to be able to move on the outside of the bottom board 10 so as to drive the second blade member 50; two shock absorbing members 90 and 90 provided on single end sides of the elongated holes 10b and 10c so as to allow contact by (the driving pin 70a of) the first blade driving member 70 and (the driving pin 80a of) the second blade driving member 80, respectively; a setting member (not shown) for setting the first blade member 40 and the second blade member 50 (that is, the first blade driving member 70 and the second blade driving member 80) to the setting position for prior to the shutter operation (prior to the exposing operation); a driving mechanism (not shown) for driving the setting member; two electromagnets (not shown) for attractively holding the first blade driving member 70 and the second blade driving member 80 in the setting positions; and so forth.

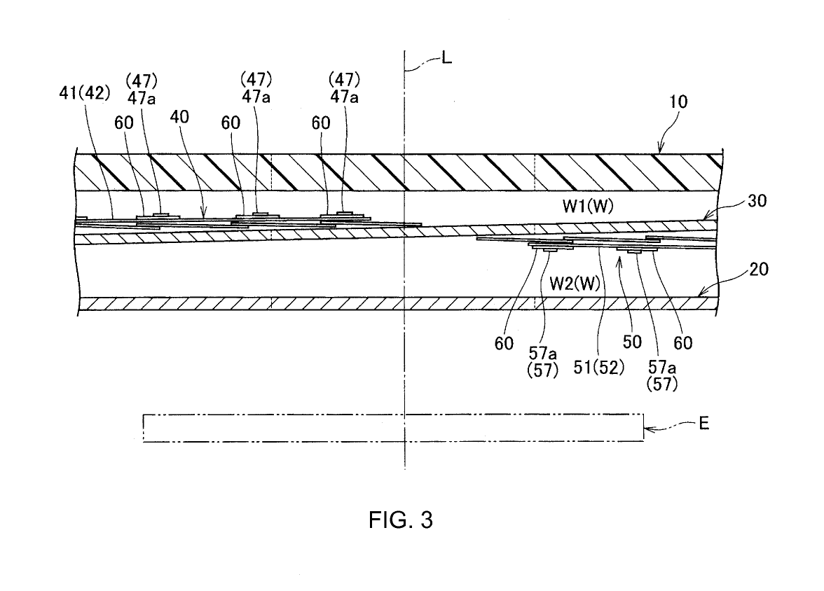

Note that a camera is structured from the focal plane shutter that is structured as described above, an imaging element E (referencing FIG. 3), such as a CCD, a housing (not shown), and the like.

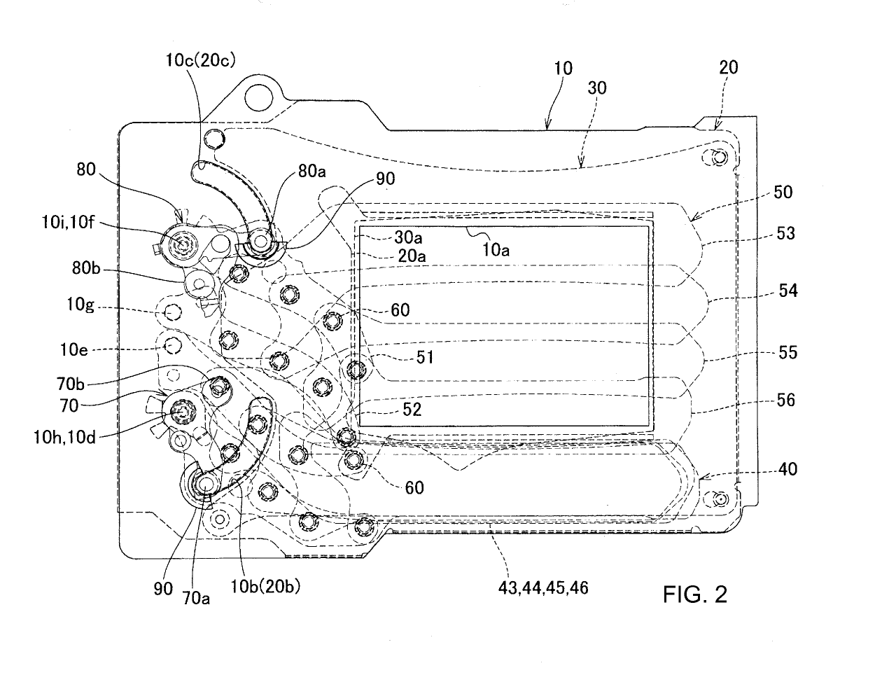

The bottom board 10, as illustrated in FIG. 1 and FIG. 2, is formed in an essentially rectangular flat plate shape, and has: an opening portion 10a for exposure that is essentially rectangular; an elongated hole 10b and an elongated hole 10c wherein arc parts and semicircular parts are connected; supporting shafts 10d and 10e that are provided standing in the inside (the blade chamber side) for supporting the first blade member 40 so as to be able to rotate; supporting shafts 10f and 10g provided standing on the inside (the blade chamber side) for supporting the second blade member 50 so as to be able to rotate; a supporting shaft 10h provided standing on the outside for supporting the first blade driving member 70 so as to be able to rotate; a supporting shaft 10i that is provided standing on the outside for supporting the second blade driving member 80 so as to be able to rotate; and so forth.

The back board 20, as illustrated in FIG. 1 through FIG. 3, is disposed parallel to the bottom board 10, at a prescribed distance therefrom, and secured removably to the bottom board 10, and has an opening portion 20a for exposure that corresponds to the opening hole 10a, with a slightly larger area of opening; and elongated holes 20b and 20c, corresponding to the elongated holes 10b and 10c of the bottom board 10; and so forth.

Moreover, the back board 20, in coordination with the bottom board 10, defines a blade chamber W for containing the blade members (the first blade member 40 and the second blade member 50).

As illustrated in FIG. 1 through FIG. 3, the intermediate board 30 has an opening portion 30a for exposure, corresponding to the opening portion 10a, with a slightly larger area of opening, and is disposed interposed between the bottom board 10 and the back board 20 in a region outside of the region corresponding to the elongated holes 10b, 10c, 20b, and 20c of the bottom board 10 and the back board 20 (the region wherein the driving pins 70a and 80a move), to define, in cooperation with the bottom board 10, a first blade chamber W1 that contains the first blade member 40, and to define, in cooperation with the back board 20, a second blade chamber W2 that contains the second blade member 50, that is, is formed so as to cut in half the blade chamber W into a first blade chamber W1 and a second blade chamber W2, and to guide the first blade members 40 so as to be able to move along the surface thereof on one side, and the second blade members 50 to as to be able to move along the surface on the other side.

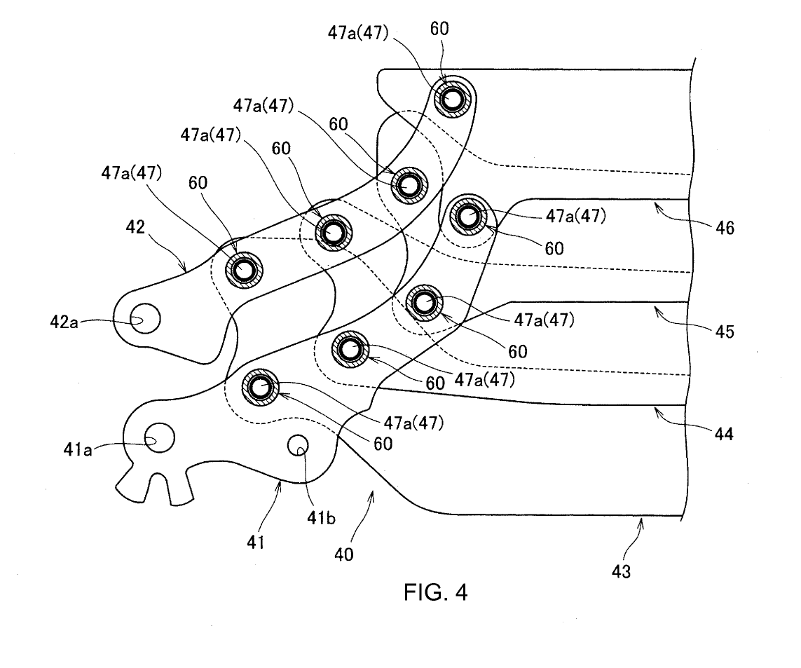

As illustrated in FIG. 1, FIG. 2, FIG. 3, and FIG. 4, the first blade member 40 is structured from two arms 41 and 42, four blades 43, 44, 45, and 46, eight rivets 47 that are connecting members for connecting together the two arms 41 and 42 and the four blades 43, 44, 45, and 46, and the like.

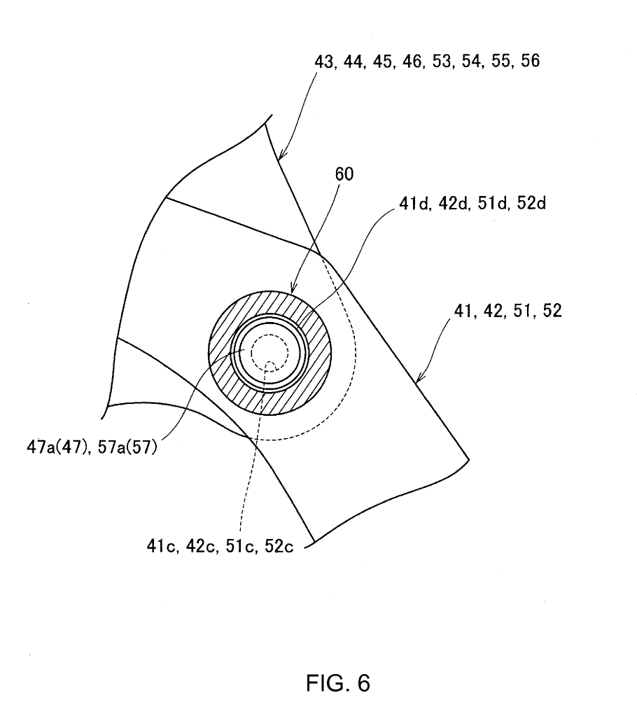

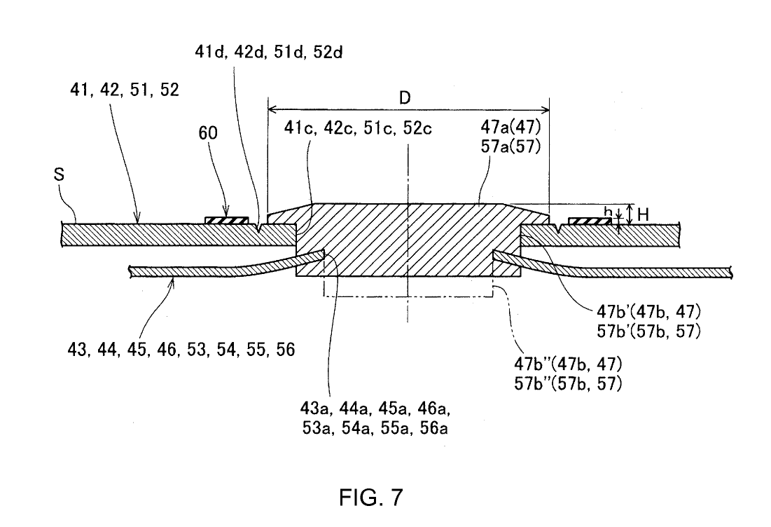

As illustrated in FIG. 4, FIG. 6, and FIG. 7, the arms 41 are formed in flat plate shapes, and each has: a bearing hole 41a through which a supporting shaft 10d passes, formed so as to be able to rotate; a connecting hole 41b to which a driving pin 70a of the first blade driving member 70 is connected; four fitting holes 41c into which (large diameter trunk portions 47b′ of) trunk portions 47b of the rivets 47 are fitted; four circular ring-shaped marking lines 41d (with diameters that are larger than the outer diameter of the head portions 47a of the rivets 47), formed around the fitting holes 41c; and so forth.

As illustrated in FIG. 4, FIG. 6, and FIG. 7, the arms 42 are formed in flat plate shapes, and each has: a bearing hole 42a through which a supporting shaft 10e passes, formed so as to be able to rotate; four fitting holes 42c into which (large diameter trunk portions 47b′ of) trunk portions 47b of the rivets 47 are fitted; four circular ring-shaped marking lines 42d (with diameters that are larger than the outer diameter of the head portions 47a of the rivets 47), formed around the fitting holes 42c; and so forth.

As illustrated in FIG. 4, FIG. 6, and FIG. 7, each of the four blades 43 (and 44, 45, and 46) is formed in a flat plate shape and has two fitting holes 43a (44a, 45a, and 46a) into which (the reduced diameter trunk portions 47b″ of) the trunk portions 47b of the rivets 47 are fitted, where (the reduced diameter trunk portion 47b″ of) the trunk portion 47b of the rivet 47 that is fitted into the fitting hole 41c of the arm 41 is fitted into one of the fitting holes 43a (44a, 45a, and 46a) and a crimping process is performed thereon to secure it integrally, and where (the reduced diameter trunk portion 47b″ of) the trunk portion 47b of the rivet 47 that is fitted into the fitting hole 42c of the arm 42 is fitted into the other of the fitting holes 43a (44a, 45a, and 46a) and a crimping process is performed thereon to secure it integrally.

As illustrated in FIG. 7, the rivet 47 has a flanged head portion 47a and a trunk portion 47b that is formed connected to the head portion 47a and that, prior to crimping, is formed in a two-stage circular column shape.

As illustrated in FIG. 7, the head portion 47a forms a circular flange shape with a prescribed height H and an outer diameter D that is larger than that of the fitting holes 41c and 42c of the arms 41 and 42.

As illustrated in FIG. 7, the trunk portion 47b has: a large diameter trunk portion 47b′ that is formed with an outer diameter that is smaller than that of the head portion 47a, and that fits into the fitting holes 41c and 42c of the arms 41 and 42 so as to be able to rotate; and a reduced diameter trunk portion 47b″ (the part indicated by the double dotted lines in FIG. 7) that is formed with an outer diameter that is smaller than that of the large diameter trunk portion 47b′ and that is fitted into the fitting holes 43a, 44a, 45a, and 46a of the blades 43, 44, 45, and 46.

As described above, in the first blade member 40, the two arms 41 and 42 and the four blades 43, 44, 45, and 46 are connected by rivets 47, and in a state wherein the rivets 47 and the blades 43, 44, 45, and 46 are secured together, the arms 41 and 42 and the blades 43, 44, 45, and 46 are assembled so that each is able to rotate relatively around the respective rivets 47, where the head portion 47a of a rivet 47 slides relative to one side face S of the arms 41 and 42, and the large diameter trunk portion 47b′ of the rivet 47 is able to slide relative to the fitting holes 41c and 42c of the arms 41 and 42.

Moreover, as illustrated in FIG. 1, the four blades 43, 44, 45, and 46 are opened by the arm 41 being driven by the first blade driving member 70 in the direction that is upward in the figure (the counterclockwise direction), to close the opening portion 10a (and 20a and 30a), while, on the other hand, as illustrated in FIG. 2, the four blades 43, 44, 45, and 46 are caused to overlay each other through being driven in the direction that is downward in the figure (the clockwise direction) by the first blade driving member 70 to open the opening portion 10a (and 20a and 30a).

Moreover, as illustrated in FIG. 3, the first blade member 40 not only is driven open/closed along the surface on the one side of the intermediate board 30, but also the adhesive members 60 that are provided on the arms 41 and 42 are disposed so as to face the intermediate board 30 on opposite sides (that is, to face the inside of the bottom board 10), making it possible to prevent the adhesive member 60 from interfering with, and sticking to, the intermediate board 30, thus enabling the first blade member 40 to move smoothly along the intermediate board 30.

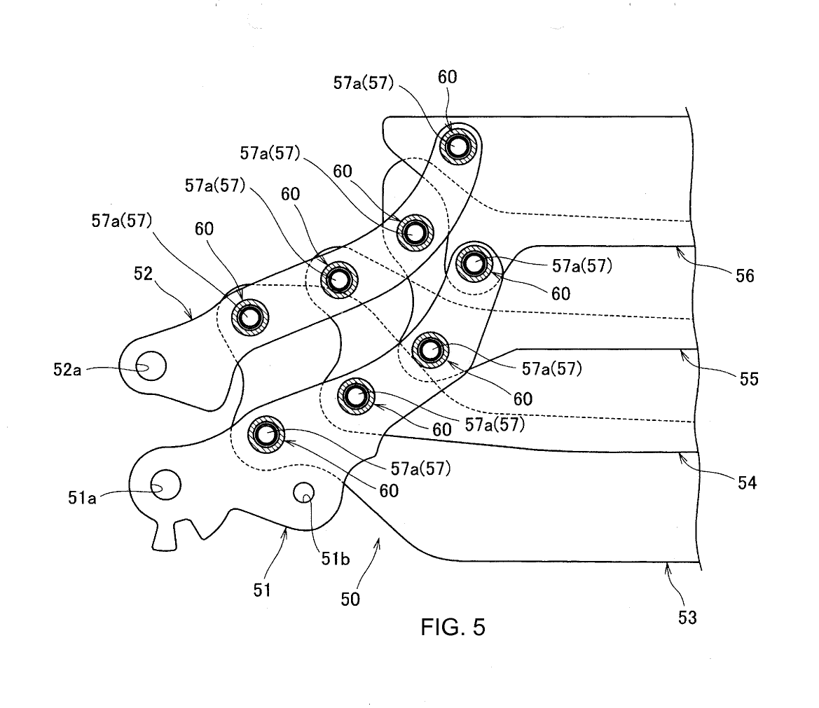

As illustrated in FIG. 1, FIG. 2, FIG. 3, and FIG. 5, the second blade member 50 is structured from two arms 51 and 52, four blades 53, 54, 55, and 56, eight rivets 57 that are connecting members for connecting together the two arms 51 and 52 and the four blades 53, 54, 55, and 56, and the like.

As illustrated in FIG. 5, FIG. 6, and FIG. 7, the arms 51 are formed in flat plate shapes, and each has: a bearing hole 51a through which a supporting shaft 10f passes, formed so as to be able to rotate; a connecting hole 51b to which a driving pin 80a of the second blade driving member 80 is connected; four fitting holes 51c into which (large diameter trunk portions 57b′ of) trunk portions 57b of the rivets 57 are fitted; four circular ring-shaped marking lines 51d (with diameters that are larger than the outer diameter of the head portions 57a of the rivets 57), formed around the fitting holes 51c; and so forth.

As illustrated in FIG. 5, FIG. 6, and FIG. 7, the arms 52 are formed in flat plate shapes, and each has: a bearing hole 52a through which a supporting shaft 10g passes, formed so as to be able to rotate; four fitting holes 52c into which (large diameter trunk portions 57b′ of) trunk portions 57b of the rivets 57 are fitted; four circular ring-shaped marking lines 52d (with diameters that are larger than the outer diameter of the head portions 57a of the rivets 57), formed around the fitting holes 52c; and so forth.

As illustrated in FIG. 5, FIG. 6, and FIG. 7, each of the four blades 53 (and 54, 55, and 56) is formed in a flat plate shape and has two fitting holes 53a (54a, 55a, and 56a) into which (the reduced diameter trunk portions 57b of) the trunk portions 57b of the rivets 57 are fitted, where (the reduced diameter trunk portion 57b″ of) the trunk portion 57b of the rivet 57 that is fitted into the fitting hole 51c of the arm 51 is fitted into one of the fitting holes 53a (54a, 55a, and 56a) and a crimping process is performed thereon to secure it integrally, and where (the reduced diameter trunk portion 57b″ of) the trunk portion 57b of the rivet 57 that is fitted into the fitting hole 52c of the arm 52 is fitted into the other of the fitting holes 53a (54a, 55a, and 56a) and a crimping process is performed thereon to secure it integrally.

As illustrated in FIG. 7, the rivet 57 has a flanged head portion 57a and a trunk portion 57b that is formed connected to the head portion 57a and that, prior to crimping, is formed in a two-stage circular column shape.

As illustrated in FIG. 7, the head portion 57a forms a circular flange shape with a prescribed height H and an outer diameter D that is larger than that of the fitting holes 51c and 52c of the arms 51 and 52.

As illustrated in FIG. 7, the trunk portion 57b has: a large diameter trunk portion 57b′ that is formed with an outer diameter that is smaller than that of the head portion 57a, and that fits into the fitting holes 51c and 52c of the arms 51 and 52 so as to be able to rotate; and a reduced diameter trunk portion 57b″ (the part indicated by the double dotted lines in FIG. 7) that is formed with an outer diameter that is smaller than that of the large diameter trunk portion 57b′ and that is fitted into the fitting holes 53a, 54a, 55a, and 56a of the blades 53, 54, 55, and 56.

As described above, in the second blade member 50, the two arms 51 and 52 and the four blades 53, 54, 55, and 56 are connected by rivets 57, and in a state wherein the rivets 57 and the blades 53, 54, 55, and 56 are secured together, the arms 51 and 52 and the blades 53, 54, 55, and 56 are assembled so that each is able to rotate relatively around the respective rivets 57, where the head portion 57a of a rivet 57 slides relative to one side face S of the arms 51 and 52, and the large diameter trunk portion 57b′ of the rivet 57 is able to slide relative to the fitting holes 51c and 52c of the arms 51 and 52.

Moreover, as illustrated in FIG. 1, the four blades 53, 54, 55, and 56 are overlapped together by the arm 51 being driven by the second blade driving member 80 in the direction that is upward in the figure (the counterclockwise direction), to open the opening portion 10a (and 20a and 30a), while, on the other hand, as illustrated in FIG. 2, the four blades 53, 54, 55, and 56 are deployed through being driven in the direction that is downward in the figure (the clockwise direction) by the first blade driving member 80 to close the opening portion 10a (and 20a and 30a).

Moreover, as illustrated in FIG. 3, the second blade member 50 not only is driven open/closed along the surface on the other side of the intermediate board 30, but also the adhesive members 60 that are provided on the arms 51 and 52 are disposed so as to face the intermediate board 30 on opposite sides (that is, to face the inside of the back board 20), making it possible to prevent the adhesive member 60 from interfering with, and sticking to, the intermediate board 30, thus enabling the second blade member 50 to move smoothly along the intermediate board 30.

As illustrated in FIG. 4, FIG. 5, FIG. 6, and FIG. 7, the adhesive member 60 is formed in a circular ring shape from a double-sided adhesive sheet that is in the form of a thin film, and is formed with an inner diameter that is larger than the marking lines 41d, 42d, 51d, and 52d of the arms 41, 42, 51, and 52, and with a prescribed outer diameter able to secure the desired area.

Here the double-sided adhesive sheet for forming the adhesive member 60 may use, for example, a three-layer structure that has a polyester film or a non-woven fabric as a base material with an acrylic adhesive agent coated on both surfaces thereof.

Moreover, as illustrated in FIG. 7, the thickness dimension of the adhesive members 60 may be formed so that, when in a state wherein it is adhered to one face S of the arm 41, 42, 51, or 52, the thickness dimension h thereof is less than the height dimension H of the head portions 47a and 57a of the rivets 47 and 57.

Moreover, the adhesive members 60 may each be peeled from a sheet wherein multiple circular ring shapes are punched in advance on a liner (a flat paper), and applied to one face S of each of the arms 41, 42, 51, and 52 of the first blade member 40 and the second blade member 50 to the outsides of the head portions 47a and 57a of the rivets 47 and 57, using the marking lines 41d, 42d, 51d, and 52d theresurrounding as guides.

Because the circular ring-shaped adhesive members 60 are provided in this way around the head portions 47a and 57a of the rivets 47 and 57 on one face S of the arms 41, 42, 51, and 52 of the first blade member 40 and the second blade member 50, for the most part the rubbing debris, and the like, that is produced from the regions of contact between the head portions 47a and 57a and the arms 41, 42, 51, and 52 (on one face S thereof) adhere to, and are trapped by, the thin film-shaped adhesive members 60, that are provided in the vicinity thereof, prior to being scattered due to the effects of vibrating off, such as due to centripetal force accompanying operation of the arms 41, 42, 51, and 52, when adhered (through static electricity, or the like) in the area of the head portions 47a and 57a.

Here the provision of the adhesive members 60 on only one face S each of the arms 41, 42, 51, and 52 wherein the head portions 47a and 57a of the rivets 47 and 57 are positioned reduces the number of components and also traps, efficiently, the rubbing debris, and the like, that is produced, preventing scattering thereof.

Moreover, the adhesive members 60 are provided with a thickness h so as to not protrude further than the head portions 47a and 57a of the rivets 47 and 57, making it possible to prevent the adhesive members 60 from interfering with, and sticking to, the stationary members such as the bottom board 10, and the like, enabling the first blade member 40 and the second blade member 50 to move smoothly.

Furthermore, the provision of the circular ring-shaped marking lines 41d, 42d, 51d, and 52d around the head portions 47a and 57a of the rivets 47 and 57 on one face S each of the arms 41, 42, 51, and 52 enables the marking lines 41d, 42d, 51d, and 52d to be used as guides enabling the adhesive members 60 to be adhered with high precision at the prescribed positions around the head portions 47a and 57a on the outsides thereof (so as to not be adhered over the marking lines), enabling the adhesion work to be carried out easily.

As illustrated in FIG. 1 and FIG. 2, the first blade driving member 70 is provided with a driving pin 70a to which the arm 41 of the first blade member 40 is connected, an engaging portion 70b for engaging the setting member when setting to the setting position for prior to the shutter operation (prior to the exposing operation) to apply a rotational force in the counterclockwise direction, and an attracted portion (not shown) that is attracted by an electromagnet.

Given this, the first blade driving member 70 is supported so as to be able to rotate, by a supporting shaft 10h on the outside of the bottom board 10, and biased rotationally in the clockwise direction by a biasing spring (not shown), where the driving pin 70a is inserted movably into the elongated holes 10b and 20b and connected to the arm 41 of the first blade member 40, wherein, in a resting state, the first blade member 40 is rotated in the clockwise direction by the biasing spring to move to an open position, and the driving pin 70a contacts the shock absorbing member 90, where, on the other hand, the first blade member 40 is rotated in the counterclockwise direction by the setting member to move to the closed position, and, at the time of an exposing operation due to a signal such as a release signal, or the like, is held in the setting position for prior to the shutter operation through the attracted portion being attracted through the application of an electric current to the electromagnet, where the removal of the current from the electromagnet releases the attraction of the magnetic force, so that the first blade member 40 will be rotated in the clockwise direction by the biasing force of the biasing spring, to move to the open position.

As illustrated in FIG. 1 and FIG. 2, the second blade driving member 80 is provided with a driving pin 80a to which the arm 51 of the second blade member 50 is connected, an engaging portion 80b for engaging the setting member when setting to the setting position for prior to the shutter operation (prior to the exposing operation) to apply a rotational force in the counterclockwise direction, and an attracted portion (not shown) that is attracted by an electromagnet.

Given this, the second blade driving member 80 is supported so as to be able to rotate, by a supporting shaft 10i on the outside of the bottom board 10, and biased rotationally in the clockwise direction by a biasing spring (not shown), where the driving pin 80a is inserted movably into the elongated holes 10c and 20c and connected to the arm 51 of the second blade member 50, wherein, in a resting state, the second blade member 50 is rotated in the clockwise direction by the biasing spring to move to a closed position, and the driving pin 80a contacts the shock absorbing member 90, where, on the other hand, the second blade member 50 is rotated in the counterclockwise direction by the setting member to move to the open position, and, at the time of an exposing operation due to a signal such as a release signal, or the like, is held in the setting position for prior to the shutter operation through the attracted portion being attracted through the application of an electric current to the electromagnet, where the removal of the current from the electromagnet releases the attraction of the magnetic force, so that the second blade member 50 will be rotated in the clockwise direction by the biasing force of the biasing spring, to move to the open position.

The shock absorbing members 90 and 90 are formed from, for example, rubber material that is capable of elastic deformation, and as illustrated in FIG. 1 and FIG. 2, is fitted into, and secured within, the semi-circular part of one-end sides of the elongated holes 10b and 10c of the base plate 10 so as to mitigate the impact by receiving contact by the driving pins 70a and 80a at the completion of the shutter operations.

The operation of this focal plane shutter will be explained next in reference to FIG. 1 and FIG. 2.

First, in a resting state after the completion of a shutter operation (after the completion of an exposing operation), the first blade driving member 70 rotates in the clockwise direction, as illustrated in FIG. 2, so that the driving pin 70a is stopped by contacting the shock absorbing member 90, and the first blade member 40 stops in an overlapping position, opening the opening portion 10a, and the second blade driving member 80 rotates in the clockwise direction, and is stopped by the driving pin 80a contacting the shock absorbing member 90, and the second blade member 50 stops in a deployed position, closing the opening portion 10a.

Here, when a shutter operation preparation command is issued through, for example, a release operation, the setting operation is carried out by the setting member, and, as illustrated in FIG. 1, the first blade driving member 70 rotates in the counterclockwise direction to be positioned at the setting position for prior to a shutter operation (a state wherein the first blade member 40 is deployed to close the opening portion 10a), and additionally the second blade driving member 80 rotates in the counterclockwise direction to be positioned in the setting position for prior to the shutter operation (a state wherein the second blade member 50 is overlapping, to open the opening portion 10a), after which, when an electric current is applied to the electromagnet, the attracted portions of each are attracted, so that the first blade driving member 70 and the second blade driving member 80 hold the setting positions against the biasing forces of the biasing springs that apply rotational biases in the clockwise direction. Given this, the setting member returns to the resting position, releasing the state wherein the clockwise rotation of the first blade driving member 70 and the second blade driving member 80 is constrained.

Following this, when, at the desired time, the electric current to one of the electromagnets is cut, then, as illustrated in FIG. 1, the first blade driving member 70 is rotated in the clockwise direction by the biasing force of the biasing spring, and the driving pin 70a moves within the elongated hole 10b to contact the shock absorbing member 90, and the first blade member 40 stops at an overlapping position to open the opening portion 10a.

Following this, when, at the desired time, the electric current to the other electromagnet is cut, then, as illustrated in FIG. 1, the second blade driving member 80 is rotated in the clockwise direction by the biasing force of the biasing spring, and the driving pin 80a moves within the elongated hole 10c to contact the shock absorbing member 90, and the second blade member 50 stops at a deployed position to close the opening portion 10a.

Given the above, the first blade member 40 and the second blade member 50 carry out the opening/closing operation of the opening portion 10a, to complete a single shutter operation.

At the time of the shutter operation (the opening/closing operation) described above, rubbing debris, or the like, is produced through the relative movement (sliding) between the arms 41, 42, 51, and 52 and the rivets 47 and 57, where the rubbing debris, or the like, that is produced adheres to the surfaces (on one face S) of the arms 41, 42, 51, and 52 (through, for example, static electricity) in the vicinity of the rivets 47 and 57, but because the thin film adhesive members 60 are provided in the vicinity of the rivets 47 and 57, the contamination, such as the rubbing debris, or the like, that is produced, is trapped through adhering to the adhesive member 60, prior to being vibrated off and scattering, caused by the operation of the blade members (the first blade member 40 and the second blade member 50). Because of this, this is able to reduce or prevent contamination of rubbing debris, or the like, that would arrive at and adhere to the imaging element E, or the like, that is disposed in the back due to the scattering from within the blade chamber W that is formed from the bottom board 10 and the back board 20.

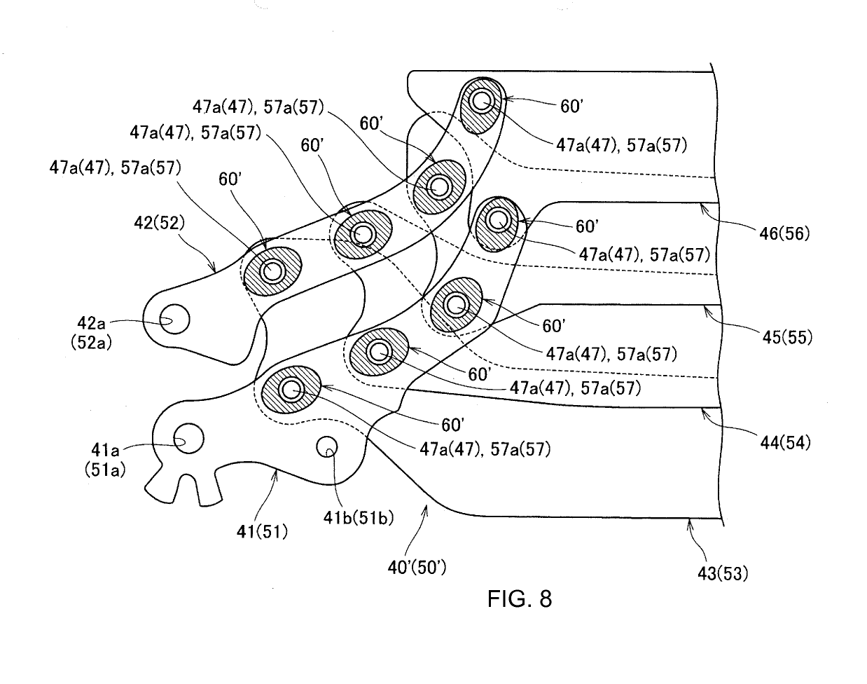

FIG. 8 illustrates another example of an adhesive member that is provided on a blade member, wherein an adhesive member 60′, having an elliptical outline, being adhered to one face S of the first blade members 40′ and the second blade members 50′, where those structures that are identical to those in the example set forth above are assigned identical codes, and explanations thereof are omitted. Note that the second blade member 50′ is shaped slightly differently from the first blade member 40′, but, for convenience in explanation, the explanation will use identical drawings.

In the present example, the first blade member 40′ and second blade member 50′ are identical to those of the example described above with the exception of the point that the marking lines are not provided.

As illustrated in FIG. 8, the adhesive member 60′ is formed in a shape wherein the outline is elliptical, from a thin film-shaped double-sided adhesive sheet, having a circular hole with an inner diameter that is larger than the outer diameter D of the head portions 47a and 57a of the rivets 47 and 57 that are attached to the arms 41, 42, 51, and 52, formed so as to produce a larger surface area than that of the adhesive member 60 described above.

Here, as described above, the double-sided adhesive sheet for forming the adhesive member 60′ may use, for example, a three-layer structure that has a polyester film or a non-woven fabric as a base material with an acrylic adhesive agent coated on both surfaces thereof.

In this example, the area for capturing the rubbing debris, and the like, is increased by an amount commensurate with the increase in area of the adhesive member 60′, enabling the rubbing debris, or the like, to be trapped more reliably.

While, in the example described above, the shape of the adhesive member is shown as a circular ring-shaped adhesive member 60 or an adhesive member 60′ wherein the outline is an elliptical shape, there is no limitation thereto, and insofar as it is provided in the vicinity of the connecting members (the rivets 47 and 57), an arc-shaped adhesive member, a form wherein a plurality of annular adhesive members with different diameters are disposed in concentric circles, or some other form may be employed instead.

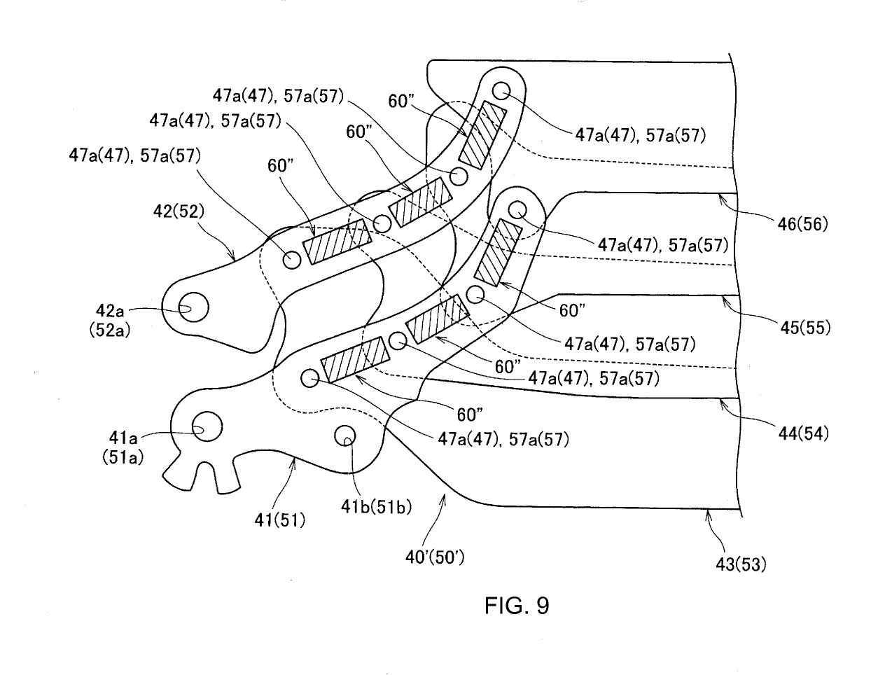

FIG. 9 illustrates yet another example of an adhesive member that is provided on a blade member, wherein an adhesive member 60″, having an essentially square outline, being adhered to one face S of the first blade members 40′ and the second blade members 50′, where those structures that are identical to those in the example set forth above are assigned identical codes, and explanations thereof are omitted. Note that the second blade member 50′ is shaped slightly differently from the first blade member 40′, but, for convenience in explanation, the explanation will use identical drawings.

In the present example, the first blade member 40′ and second blade member 50′ are identical to those of the example described above with the exception of the point that the marking lines are not provided.

As illustrated in FIG. 9, the adhesive member 60″ is formed in a shape wherein the outline is essentially a square shape, from a thin film-shaped double-sided adhesive sheet, disposed between the head portions 47a and 57a of the rivets 47 and 57 that are attached to the arms 41, 42, 51, and 52.

Here, as described above, the double-sided adhesive sheet for forming the adhesive member 60″ may use, for example, a three-layer structure that has a polyester film or a non-woven fabric as a base material with an acrylic adhesive agent coated on both surfaces thereof.

Given this example, the adhesive member 60″ is disposed between each of the head portions 47a and 57a, enabling the rubbing debris, and the like, to be trapped reliably while reducing the area of the adhesion.

While, in the example described above, the shape of the adhesive member is shown as an adhesive member 60″ wherein the outline is a square shape, there is no limitation thereto, and insofar as it is provided between the connecting members (the rivets 47 and 57), an adhesive member of an elliptical shape, or an adhesive member of some other shape, may be employed instead.

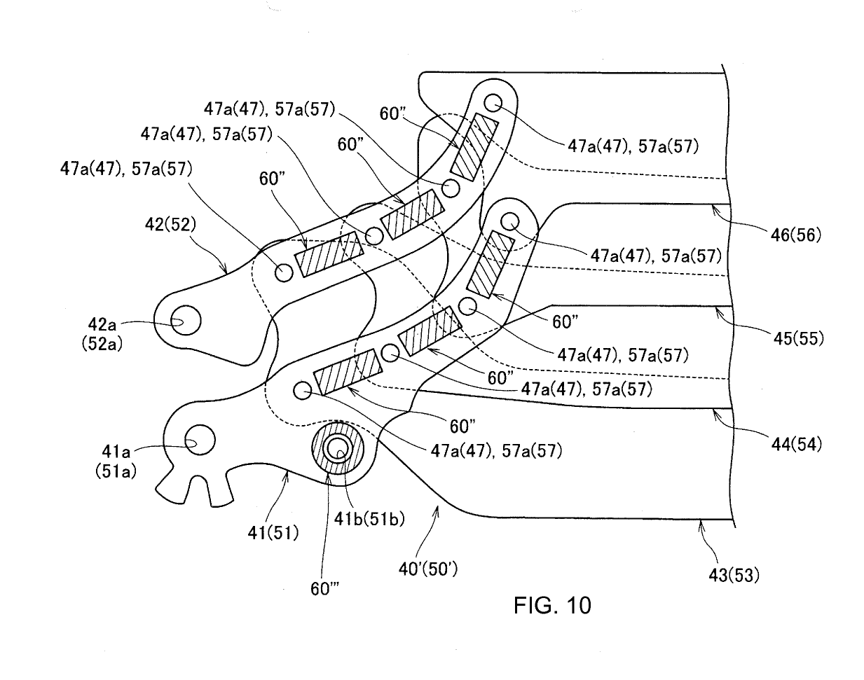

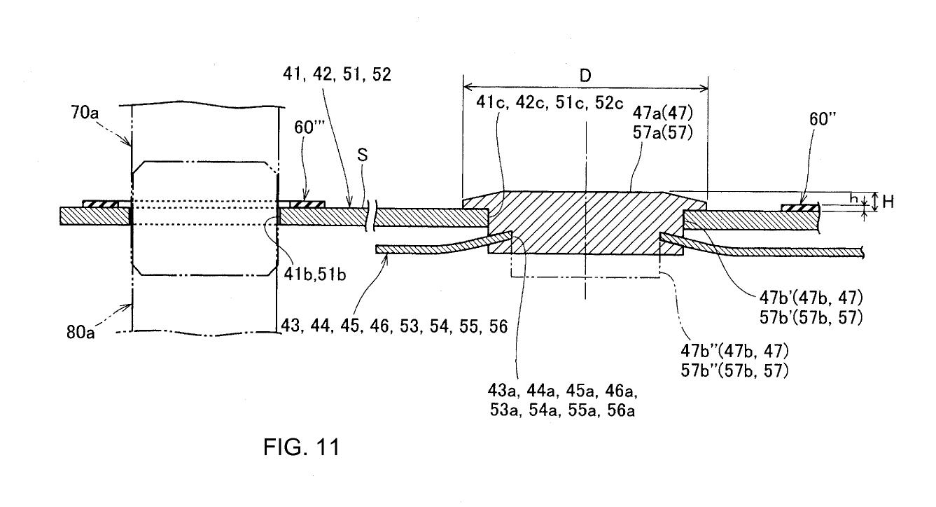

FIG. 10 and FIG. 11 illustrate yet other examples of adhesive members provided on the blade members, where, in addition to the adhesive member 60″ that is illustrated in FIG. 9, described above, ring-shaped adhesive members 60″ are adhered on one face S of the first blade member 40′ and of the second blade member 50′, and around the connecting holes 41b and 51b, where those structures that are identical to those in the examples set forth above are assigned identical codes and explanations thereof are omitted. Note that the second blade member 50′ is shaped slightly differently from the first blade member 40′, but, for convenience in explanation, the explanation will use identical drawings.

As illustrated in FIG. 10 and FIG. 11 the adhesive member 60′″ is formed in a ring shape from a thin film-shaped double-sided adhesive sheet, and disposed around the connecting holes 41b and 51b into which the driving pins 70a and 80a are inserted.

Here, as described above, the double-sided adhesive sheet for forming the adhesive member 60′″ may use, for example, a three-layer structure that has a polyester film or a non-woven fabric as a base material with an acrylic adhesive agent coated on both surfaces thereof.

Given this example, when there is relative sliding with the driving pins 70a and 80a in a state wherein they are inserted into the connecting holes 41b and 51b, contamination, such as the rubbing debris that is produced in the vicinity of the connecting holes 41b and 51b, is trapped through adhering immediately to the adhesive member 60′″. Because of this, it is possible to reduce or prevent contamination such as rubbing debris, and the like, that is produced and then scattered, where this rubbing debris, and the like would have arrived at, and adhered to, the imaging element E, or the like, that is disposed behind.

While, in the example described above, the shape of the adhesive member is shown as an adhesive member 60′″ wherein the outline is a ring shape, there is no limitation thereto, and insofar as it is provided in the vicinity the connecting holes 41b and 51b, an adhesive member of an arc shape, or an adhesive member of some other shape, may be employed instead.

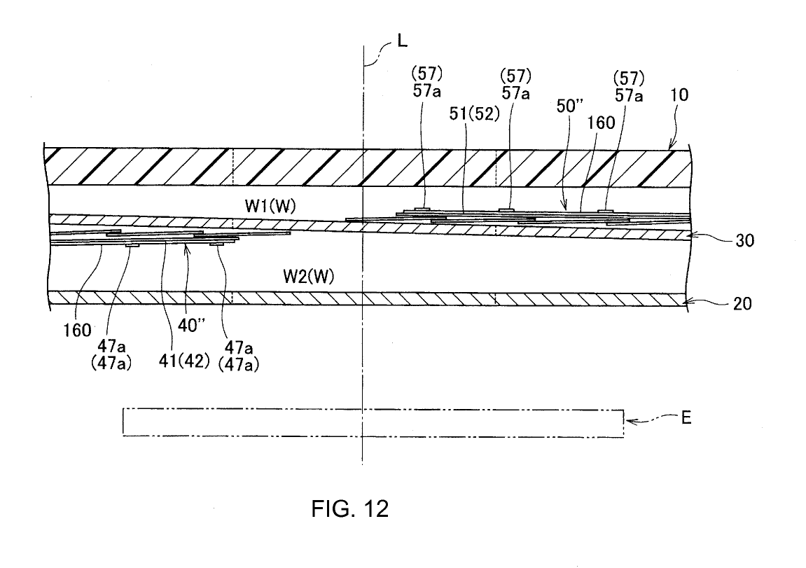

FIG. 12 through FIG. 15 illustrate yet another example wherein the first blade members 40″, as blade members, are disposed in a second blade chamber W2 that is defined between the back board 20 and the intermediate board 30, and the second blade member 50″ is disposed in the first blade chamber W1 that is defined between the bottom board 10 and the intermediate board 30, wherein adhesive members 160 that form planes are adhered covering one face S of the first blade member 40″ and of the second blade member 50″, where the other structures are identical to those of the examples set forth above, and identical codes are assigned to identical structures and explanations thereof are omitted.

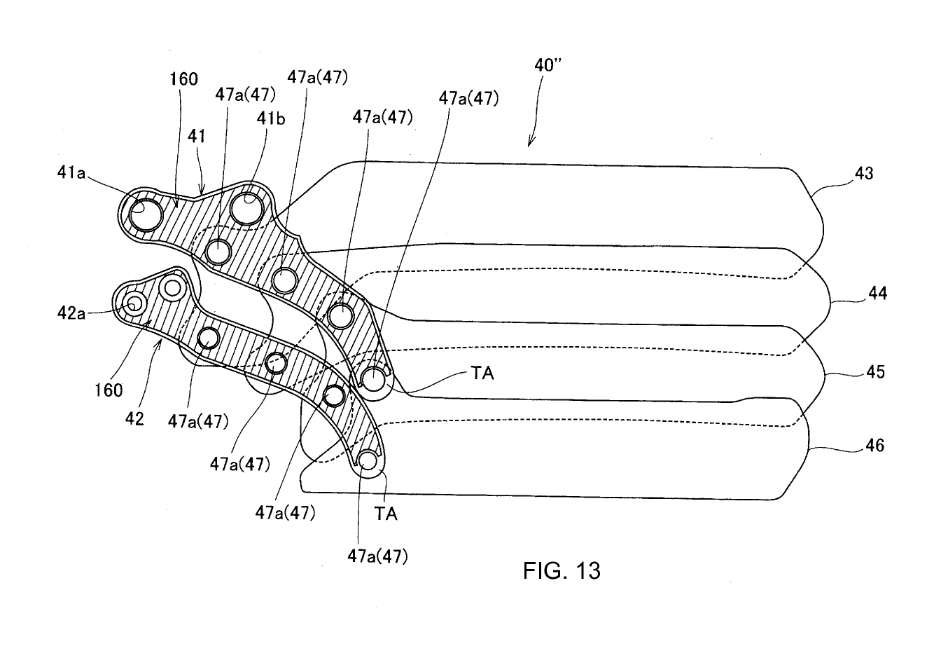

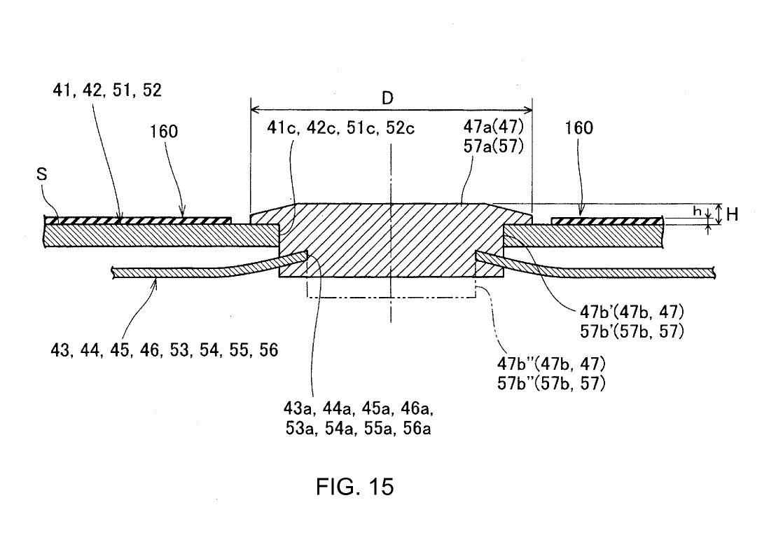

In this example, as illustrated in FIG. 13 and FIG. 15, the first blade member 40″ includes: two arms 41 and 42; four blades 43, 44, 45, and 46; four rivets 47 as connecting members; and adhesive members 160 disposed so as to form a plane that covers the regions of one face S of the arms 41 and 42, excluding the head portions 47a of the rivets 47.

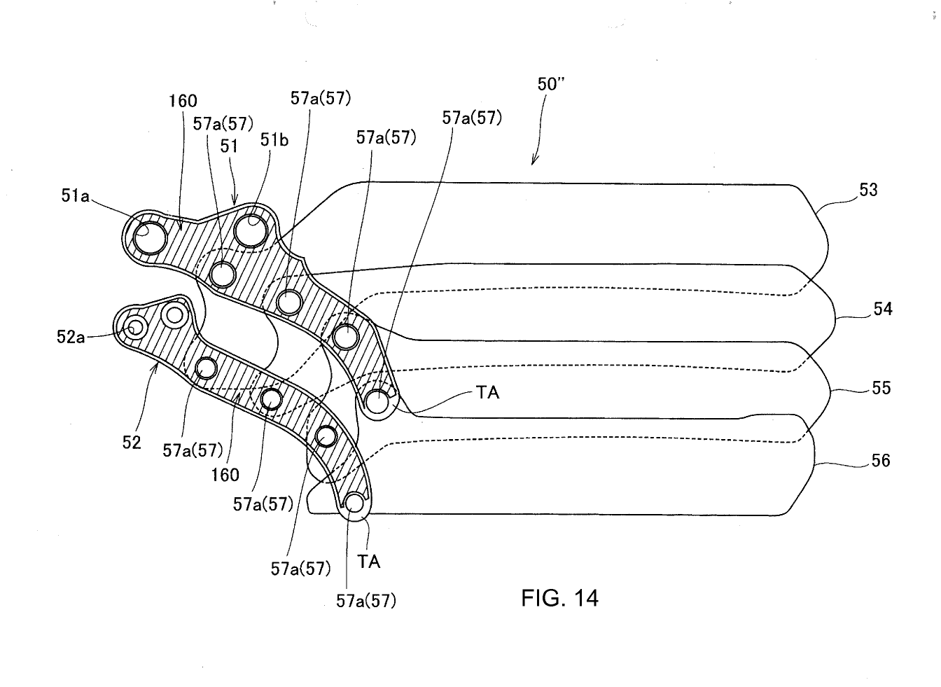

Moreover, as illustrated in FIG. 14 and FIG. 15, the first blade member 50″ includes: two arms 51 and 52; four blades 53, 54, 55, and 56; four rivets 57 as connecting members; and adhesive members 160 disposed so as to form a plane that covers the regions of one face S of the arms 51 and 52, excluding the head portions 57a of the rivets 57.

Specifically, as illustrated in FIG. 13 and FIG. 15, the adhesive members 160 are disposed so as to expose the head portions 47a and 57a through circular holes that are larger than the external diameter D of the head portions 47a and 57a on one faces S of the arms 41, 42, 51, and 52, and to expose slightly, with a prescribed width, the outer edge portions of the arms 41, 42, 51, and 52, and, additionally, to expose the regions TA on the free end sides from the vicinities of those rivets 47 and 57, from among the four rivets 47 and 57, that are positioned nearest toward the free end sides of the arms 41, 42, 51, and 52 (that is, excluding the region TA).

As described above, a double-sided adhesive sheet, or the like, may be used to form the adhesive member 160, and may use, for example, a three-layer structure that has a polyester film or a non-woven fabric as a base material with an acrylic adhesive agent coated on both surfaces thereof.

Because, in this way, the adhesive members 160 are arranged in the form of a plane so as to cover a region that excludes the head portions 47a and 57a, for the most part the rubbing debris, or the like, produced in the region wherein the head portions 47a and 57a and (one side face S each of) the arms 41, 42, 51 and 52 are in contact is trapped through adhesion, by the thin film-shaped adhesive member 160 that is provided to form a plane shape, prior to the scattering that is caused by the adhesion around the head portions 47a and 57a (through, for example, static electricity, or the like) and the effects of falling off due to the centrifugal force, or the like, accompanying the operation of the arms 41, 42, 51, and 52.

Providing, in this way, the adhesive members 160 in the shape of a plane (so as to cover essentially the entire surface), excluding the head portions 47a and 57a, on one face S of the arms 41, 42, 51, and 52, enables prevention of scattering by capturing, with increased efficiency commensurate with the added area of the adhesive, rubbing debris, and the like, that is produced, while reducing the number of parts.

Moreover, because here the adhesive members 160 are disposed from the vicinity of (the head portions 47a and 57a of) the rivets 47 and 57 that are positioned the nearest toward the tip end sides of the arms 41, 42, 51, and 52, excluding the region TA on the free end side (for example, excluding a semi-circular recessed shape around the head portions 47a and 57a from essentially the centers of the head portions 47a and 57a up to the tip end side), so that even if the tip end sides of the arms 41, 42, 51, and 52 were to rattle during operation, still the anticipated operating characteristics could be secured without the adhesive member 160 peeling and falling off due to, for example, deformation due to the rattling.

While in the examples set forth above adhesive members 60, 60′, 60″, 60′″, and 160 that use double-sided adhesive sheets as the adhesive members are illustrated, there is no limitation thereto, but rather an adhesive agent that is coated directly onto the surfaces of the arms 41 and 42 of the first blade members 40, 40′, and 40″, and 51 and 52 of the second blade members 50, 50′, and 50″ may be used instead.

While cases wherein the adhesive members 60, 60′, 60″, 60′″, and 160 were adhered to only a single faces S of the arms 41, 42, 51, and 52 are illustrated in the example described above, there is no limitation thereto, but rather a structure wherein they are adhered also to the other sides may be used, insofar as there is no interference with the blades 43, 44, 45, 46, 53, 54, 55, and 56.

While first blade members 40, 40′, and 40″, and second blade members 50, 50′, and 50″ that include two arms 41 and 42, and 51 and 52, and four blades 43, 44, 45, and 46 and 53, 54, 55, and 56, are illustrated as blade members in the examples described above, there is no limitation thereto, but rather a blade members that is structured from a single blade, three blades, five blades, or more on two arms may be employed instead.

While rivets 47 and 57 were illustrated as the connecting members in the examples described above, there is no limitation thereto, but rather connecting members of some other form may be employed instead insofar as the arms and blades that structure the blade members are connected so as to enable relative rotation.

While a structure is illustrated wherein first blade members 40, 40′, and 40″ and second blade members 50, 50′, and 50″ are provided as blade members, and the adhesive members 60, 60′, 60″, 60′″, and 160 are provided respectively for the first blade members 40, 40′, and 40″ and the second blade members 50, 50′, and 50″, there is no limitation thereto, but rather a structure may be employed wherein an adhesive member is provided on a single blade member in a structure wherein the shutter operation is carried out through simply moving a single blade member, which is disposed between the bottom board and the back board, without an intermediate board, from a state wherein the opening portion is open to a state wherein it is closed, or a structure may be employed wherein an adhesive member is provided on a single blade member in a structure wherein the shutter operation is carried out through a single blade member that is attached to the bottom board so as to be able to rotate, without a back board and without an intermediate board, moving from a state wherein the opening portion is open to a state wherein it is closed.

While in the examples set forth above the explanation of the operating effects of the present invention assumed a structure wherein, in a camera that includes a lens optics system, a focal plane shutter, an imaging element, and the like, the side wherein the driving members (the first blade driving member 70 and the second blade driving member 80) are disposed on a bottom board 10 (which here is the front side) faces a photographic subject side in the direction of the optical axis L of the lens optics system and a back board 20, which defines the blade chamber W in cooperation with the bottom board 10, faces the imaging element E side in the direction of the optical axis L of the lens optics system, there is no limitation thereto, but rather, conversely, similar operating effects can be obtained through a structure wherein the back board 20 side faces the photographic subject side in the direction of the optical axis L of the lens optics system, and thus the present invention may be employed in such an arrangement as well.

As described above, the focal plane shutter according to the present invention is able to reduce or prevent the scattering, and incursion into the imaging element side, of contamination, such as rubbing debris, or the like, that is produced at the blade members that are attached to the bottom board so as to be able to rotate, thus enabling imaging of higher definition images, while simplifying the structure and achieving miniaturization of the device, and thus may be used in, of course, digital cameras such as single-lens cameras, single-lens reflex cameras, mirrorless cameras, rangefinder cameras, and the like, and also to other optical instruments provided with opening portions for exposure.

1. A focal plane shutter comprising:
a bottom board having an opening portion; and
a blade member that opens/closes the opening portion, wherein
the blade member is formed from a plurality of arms supported rotatably on the bottom board, at least one blade, and a plurality of connecting members that connects the plurality of arms rotatably to the blade, and
the blade member includes an adhesive member that is provided on at least one of the plurality of arms.

2. The focal plane shutter as set forth in claim 1, wherein
the adhesive member is provided in at least a vicinity of at least one of the plurality of connecting members.

3. The focal plane shutter as set forth in claim 1, wherein
the at least one of the plurality of arms has a connecting hole for connecting a driving pin; and
the adhesive member is provided around the connecting hole.

4. The focal plane shutter as set forth in claim 1, wherein
the at least one of the plurality of connecting members includes:
a head portion that is in contact with one face of the at least one of the plurality of arms; and
a trunk portion that fits rotatably into a fitting hole of the at least one of the plurality of arms, and is fitted into a fitting hole of the blade, a crimping process being performed thereon, and
the adhesive member is provided on the one face of the at least one of the plurality of arms in a ring shape around the head portion.

5. The focal plane shutter as set forth in claim 4, wherein
a ring-shaped guideline is provided around the head portion on the one face of the at least one of the plurality of arms.

6. The focal plane shutter as set forth in claim 1, wherein
the at least one of the plurality of connecting members includes:
a head portion that is in contact with one face of the at least one of the plurality of arms; and
a trunk portion that fits rotatably into a fitting hole of the at least one of the plurality of arms, and is fitted into a fitting hole of the blade, a crimping process being performed thereon, and
the adhesive member is provided to form a plane covering a region of the one face of the at least one of the plurality of arms, excluding the head portion.

7. The focal plane shutter as set forth in claim 6, wherein
the adhesive member is provided excluding a region from a vicinity of the at least one of the plurality of connecting members, that is positioned nearest toward a free end side of the at least one of the plurality of arms, up to the free end side.

8. The focal plane shutter as set forth in claim 4, wherein
the adhesive member is formed to a thickness dimension that is less than a height dimension of the head portion.

9. The focal plane shutter as set forth in claim 1, including:
a back board being provided at a distance from the bottom board, which defines a blade chamber in cooperation with the bottom board, and having an opening portion; and
an intermediate board being provided between the bottom board and the back board, which divides the blade chamber into two parts having a first blade chamber and a second blade chamber, and having an opening portion, wherein
the blade member includes a first blade member provided in either one of the first blade chamber and the second blade chamber, which opens the opening portion, and a second blade member provided in another one of the first blade chamber and the second blade chamber, which closes the opening portion, at the time of a shutter operation, and
an adhesive member, which is provided on an arm of the first blade member, and an adhesive member, which is provided on an arm of the second blade member, are arranged so as to face in directions of respective opposite sides of the intermediate board.

10. A camera comprising:
a focal plane shutter including
a bottom board having an opening portion, and
a blade member that opens/closes the opening portion; and
an imaging element that is provided behind the focal plane shutter, wherein
the blade member is formed from a plurality of arms supported rotatably on the bottom board, at least one blade, and a plurality of connecting members that connects the plurality of arms rotatably to the blade, and
the blade member includes an adhesive member that is provided on at least one of the plurality of arms.
